(19) United States
(12) Patent Application Publication
(10) Pub. No.: US 2024/0164420 A1
(43) Pub. Date: May 23, 2024

(54) COOKING OIL REPLACEMENT

(71) Applicant: Rebekah Kee Maya, Bellingham, WA (US)

(72) Inventor: Rebekah Kee Maya, Bellingham, WA (US)

(21) Appl. No.: 18/505,053

(22) Filed: Nov. 8, 2023

Related U.S. Application Data
(60) Provisional application No. 63/426,296, filed on Nov. 17, 2022.

(51) Int. Cl. A23L 19/00; A23L 29/00; A23L 29/269

(52) U.S. Cl. CPC A23L 19/09; A23L 29/035; A23L 29/27

(57) ABSTRACT

A cooking oil replacement is provided which is usable in many different types of foods and recipes while maintaining the flavor and characteristics of the unmodified food. The cooking oil substitute works in recipes that do not include gluten or eggs and may be broadly used in cooking. The cooking oils substitute provides a significant health benefit to persons with liver disease, diabetes, or heart disease.

### PRIORITY

The present application claims the benefit of U.S. Provisional Application Ser. No. 63/426,296, filed Nov. 17, 2022, which is herein incorporated by reference in its entirety.

### THE FIELD OF THE INVENTION

The present invention relates to cooking. In particular, the present invention relates to a cooking oil alternative.

### INTRODUCTION

Oils are commonly used in cooking to provide flavor as well as modify the texture or consistency of foods. Many individuals are resistant to replacement of oils in their foods because of an inability to adequately replicate the original consistency of the food and create a food which is equally satisfying.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

In the disclosure, reference has been made to specific examples, which form a part hereof and describe how disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, such feature, structure, or characteristic may be used in connection with other embodiments whether or not explicitly described. The particular features, structures or characteristics may be combined in any suitable combination and/or sub-combinations in one or more embodiments or examples

As used herein, “adjacent” refers to near or close sufficient to achieve a desired effect. Although direct contact is common, adjacent can broadly allow for spaced apart features.

As used herein, the singular forms “a,” and, “the” include plural referents unless the context clearly dictates otherwise.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be such as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a number or numerical range endpoint by providing that a given value may be a significant digit above or a significant digit below the number or endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Dimensions, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

There have been attempts to replace cooking oil in foods to make the foods healthier. These recipes and are often not well accepted because they do not provide adequate flavor or texture in foods. Attempting to replace cooking oil is challenging because a substituted ingredient often does not work well in many types of foods and the overall flavor or texture of the food is adversely affected. In some cases, the cooking and consistency of the food is adversely altered by the substitution. Even with a desire to improve health, people tend to discontinue removal of oil from foods because the loss of food flavor or texture is significant enough to cause a loss of enjoyment in eating.

The disclosure particularly describes a cooking oil replacement which is useable to replace cooking oil in many different types of foods. The cooking oil replacement may be used in baking foods such as breads, crackers, and the like. The cooking oil replacement may be used in desserts as well as pastas and sautéing. The cooking oil replacement may be used broadly as an oil replacement and provides good flavor and texture in the foods. The cooking oil replacement provides a significant health benefit for people who have diseases such as diabetes, fatty liver and other liver diseases, heart disease, and inflammation problems. Many individuals are genetically unable to properly metabolize fats and oils. For these individuals, consumption of fats and oils leads to diseases such as heart disease. The cooking oil replacement allows these people to eliminate fats and oils from in their diet while still enjoying a large variety of foods that are satisfying to eat. The cooling oil replacement allows these people to treat their diseases and obtain good health through good diet.

The cooking oil replacement includes squash. Butternut squash (Cucurbita Moschata) is typically used because it provides a desirable color in most foods and also provides a neutral flavor which does not create an undesirable flavor in foods. Citrus fiber powder is added to the squash and provides an improvement to the texture and consistency of the cooking oil replacement that helps it better replace the functionality of the oil. A thickener is added to the cooking oil replacement to help provide a desirable consistency. The thickener is typically carrageenan or a gum thickener such as xanthan gum, Locust/carob bean gum, Guar gum, or Gellan gum, and is more preferably xanthan gum. The xanthan gum noted in the following recipes is interpreted as a thickener, more preferably a gum thickener, more preferably gum Arabic, xanthan gum, or Agar Agar, and more preferably xanthan gum.

An example cooking oil replacement includes:
1 and ⅓ cups of butternut squash
4 cups of water
4 teaspoons of citrus fiber powder
½ teaspoon of xanthan gum powder
½ teaspoon citric acid powder
1 teaspoon turmeric powder
¼ teaspoon salt

For the indicated amount of butternut squash, the cooking oil replacement typically includes between about 3 and about 5 cups of water, preferably between about 3½ and about 4½ cups of water, and more preferably about 4 cups of water. Increasing or decreasing the water will change the thickness or thinness of the cooking oil replacement and 4 cups of water works well to create the desired consistency in the cooking oil replacement.

For the indicated amount of butternut squash, the cooking oil replacement typically includes between about 1½ teaspoons and about 10 teaspoons of citrus fiber powder, preferably between about 2 teaspoons and about 6 teaspoons of citrus fiber powder, and more preferably about 4 teaspoons of citrus fiber powder.

For the indicated amount of butternut squash, the cooking oil replacement typically includes between about ⅛ teaspoon and about 1½ teaspoons of xanthan gum, preferably between about ¼ teaspoons and about 1 teaspoon of xanthan gum, and more preferably about ½ teaspoon of xanthan gum.

For the indicated amount of butternut squash, the cooking oil replacement typically includes between about ⅛ teaspoon and about 1½ teaspoons of citric acid powder, preferably between about ¼ teaspoon and about 1 teaspoon of citric acid powder, and more preferably about ½ teaspoon of citric acid powder.

For the indicated amount of butternut squash, the cooking oil replacement typically includes between about ¼ teaspoon and about 2½ teaspoons of turmeric powder, preferably between about ½ teaspoon and about 1½ teaspoons of turmeric powder, and more preferably about 1 teaspoon of turmeric powder.

For the indicated amount of butternut squash, the cooking oil replacement typically includes between about ⅛ teaspoon and about 1 teaspoon of salt, preferably between about ⅛ teaspoon and about ½ teaspoon of salt, and more preferably about ¼ teaspoon of salt.

Expressing the ingredients as a weight percentage of the weight of squash (i.e. grams per 100 grams of squash), the example cooking oil replacement includes:
100 grams of butternut squash
250 grams of water
2.8 grams of citrus fiber powder
0.3 gram of xanthan gum powder
0.7 gram of citric acid powder
0.9 gram of turmeric powder
0.5 gram of salt

For the indicated amount of butternut squash, the cooking oil replacement typically includes between about 200 grams and about 300 grams of water, preferably between about 225 grams and about 275 grams of water, and more preferably about 250 grams of water. Increasing or decreasing the water will change the thickness or thinness of the cooking oil replacement.

For the indicated amount of butternut squash, the cooking oil replacement typically includes between about 1 gram and about 7 grams of citrus fiber powder, preferably between about 2 grams and about 4 grams of citrus fiber powder, and more preferably about 2.8 grams of citrus fiber powder.

For the indicated amount of butternut squash, the cooking oil replacement typically includes between about 0.1 gram and about 1 gram of xanthan gum, preferably between about 0.2 gram and about 0.5 gram of xanthan gum, and more preferably about 0.3 gram of xanthan gum.

For the indicated amount of butternut squash, the cooking oil replacement typically includes between about 0.2 gram and about 2 grams of citric acid powder, preferably between about 0.3 gram and about 1 gram of citric acid powder, and more preferably about 0.7 gram of citric acid powder.

For the indicated amount of butternut squash, the cooking oil replacement typically includes between about 0.3 gram and about 3 grams of turmeric powder, preferably between about 0.5 gram and about 1 grams of turmeric powder, and more preferably about 0.8 gram of turmeric powder.

For the indicated amount of butternut squash, the cooking oil replacement typically includes between about 0.2 gram and about 1.5 grams of salt, preferably between about 0.3 gram and about 1 gram of salt, and more preferably about 0.5 gram of salt.

An example cooking oil substitute includes, relative to squash by weight, about 250 percent water, less than about 5 percent citrus fiber powder, less than about 1 percent xanthan gum, less than about 2 percent citric acid powder, less than about 3 percent turmeric powder, and less than about 2 percent salt. The cooking oil substitute thus contains about 8 parts citrus fiber powder to every 1 part xanthan gum. The cooking oil substitute contains about 2 parts citric acid powder and about 2.4 parts turmeric powder to every 1 part xanthan gum and about 1.4 parts salt to every 1 part xanthan gum.

In another example, the cooking oil substitute may be prepared using dried squash powder, and preferably dried butternut squash powder. The butternut squash is approximately 90 percent water and 100 grams of squash will thus yield about 10 grams of dehydrated squash. Accordingly, the 100 grams of squash in the recipe above will be replaced with about 10 grams of dehydrated squash powder and about 90 grams of additional water. For this example, the cooking oil substitute will contain approximately:
10 grams of dried butternut squash powder
340 grams of water
2.8 grams of citrus fiber powder
0.3 gram of xanthan gum powder
0.7 gram of citric acid powder
0.9 gram of turmeric powder
0.5 gram of salt

For the indicated 10 grams of dehydrated butternut squash powder, the cooking oil replacement typically includes between about 300 and about 400 grams of water, preferably between about 325 and about 375 grams of water, and more preferably about 340 grams of water. Increasing or decreasing the water will change the thickness or thinness of the cooking oil replacement.

For the indicated amount of butternut squash powder, the cooking oil replacement typically includes between about 1 and about 7 grams of citrus fiber powder, preferably between about 2 and about 4 grams of citrus fiber powder, and more preferably about 2.8 grams of citrus fiber powder.

For the indicated amount of butternut squash powder, the cooking oil replacement typically includes between about 0.1 and about 1 gram of xanthan gum, preferably between about 0.2 and about 0.5 gram of xanthan gum, and more preferably about 0.3 gram of xanthan gum.

For the indicated amount of butternut squash powder, the cooking oil replacement typically includes between about 0.2 and 2 grams of citric acid powder, preferably between about 0.3 and about 1 gram of citric acid powder, and more preferably about 0.7 gram of citric acid powder.

For the indicated amount of butternut squash powder, the cooking oil replacement typically includes between about 0.3 and about 3 grams of turmeric powder, preferably between about 0.5 and about 1 grams of turmeric powder, and more preferably about 0.8 gram of turmeric powder.

For the indicated amount of butternut squash powder, the cooking oil replacement typically includes between about 0.1 and about 1.5 grams of salt, preferably between about 0.2 and about 1 gram of salt, and more preferably about 0.5 gram of salt.

Relative to the weight of the dried butternut squash powder, the cooking oil substitute contains between about 10 and about 70 percent citrus fiber powder, preferably between about 20 and about 40 percent citrus fiber powder, and more preferably about 27 percent citrus fiber powder. The cooking oil substitute contains between about 1 and about 10 percent xanthan gum, preferably between about 2.5 and about 5 percent xanthan gum, and more preferably about 3.3 percent xanthan gum. The cooking oil replacement typically includes between about 2.5 and about 20 percent citric acid powder, preferably between about 3.3 and about 10 percent citric acid powder, and more preferably about 6.7 percent citric acid powder. The cooking oil replacement typically includes between about 3.3 and about 30 percent turmeric powder, preferably between about 5 and about 10 percent turmeric powder, and more preferably about 8 percent turmeric powder. The cooking oil replacement typically includes between about 1.6 and about 15 percent salt, preferably between about 2.5 and about 10 percent salt, and more preferably about 5 percent salt.

The cooking oil substitute is typically prepared by steaming the butternut squash to cook the butternut squash. Steaming the butternut squash produces a milder flavor in the squash where baking the squash will tend to emphasize the sugars in the squash. After cooking the squash, the squash is finely pureed in a blender. The remaining ingredients are thoroughly mixed into the squash. A blender works well to mix in the remaining ingredients. Once the cooking oil substitute is prepared, it can be used immediately or refrigerated or frozen to store the cooking oil substitute for longer periods of time.

For a cooking oil substitute prepared from dehydrated squash, the dehydrated squash powder and remaining powders may be mixed thoroughly with water such as in a blender. If the dehydrated squash powder has not been cooked, it may be cooked with water or mixed with hot or boiling water to cook and rehydrate the squash and then the squash may be mixed with the remaining ingredients.

The mixture of butternut squash, citrus fiber powder, and a gum such as xanthan gum create a cooking oil substitute which places cooking oil in many different types of foods while retaining a desirable flavor, color, and consistency or texture in the food. This results in a healthier food which is still appetizing and desirable to eat. The addition of citric acid promotes a longer shelf life. Turmeric imparts an egg color to the cooking oil substitute which maintains a pleasing color in foods where a person is also removing eggs from their diet. Turmeric also provides beneficial compounds to the user. Salt also promotes storage life and makes the cooking oil substitute salt neutral so that additional salt need not be added to a recipe when the cooking oil substitute is used.

Benefits of the ingredients are:

Butternut squash is high in potassium, which can help keep regulate blood pressure and reduce risk for stroke and heart disease. It provides fiber which helps with blood sugar regulation because it contains a type of fiber that's not easily digestible and slows the metabolism of the sugar in the squash. Butternut squash includes many vitamins, minerals, fiber, and antioxidants including calcium, iron, phosphorus, and copper. The high antioxidant content of butternut squash may help with certain conditions, including heart disease, lung cancer and mental decline. Butternut squash has cholesterol and insulin regulating properties. In general, butternut squash is preferred because it is more nutritionally well-rounded than pumpkin. Butternut squash has more Vitamin C, Omega 6, and 3 than pumpkin and provides Pantothenic Acid, Phosphorus, Thiamin, Niacin, Vitamin B6, Potassium, Magnesium, Calcium, and Iron.

Citrus fiber powder creates a smooth and oily texture in the cooking oil substitute. Citrus fiber powder helps create a desirable viscosity and also helps replicate how a cooking oil feels and works in a food recipe. This helps the cooking oil substitute better replicate the effects of cooking oil within many different types of foods and allows people to more successfully place cooking oil in their foods. Citrus fiber contributes high amounts of both insoluble and soluble fiber as well as some native pectin that improves texture, taste and stability of foods using the cooking oil substitute. The citrus fiber improves gelling, thickening, stabilizing and water-binding capabilities of the oil substitute and allows the cooking oil substitute to replace eggs as well as oil in many baked goods. The citrus fiber provides a healthy increase in dietary fiber; making foods prepared with the cooking oil substitute healthier.

A gum such as xanthan gum adds structure to the cooking oil substitute. The xanthan gum helps to bind water in the cooking oil substitute and thickens, emulsifies, and stabilizes the cooking oil substitute to prevents ingredients from separating. Xanthan gum is beneficial for lowering blood sugar and total cholesterol in people with diabetes. In some examples, locust bean gum may be used. Locust bean gum allows for a plant based cooking oil substitute.

The combination of the citrus fiber powder and a gum such as xanthan gum provides unique properties to the cooking oil substitute. As mentioned, the gum binds water and provides a water based material that is not overly thin and does not allow free water to separate from the other ingredients. Citrus fiber powder modifies the consistency and feel of the cooking oil substitute to make it feel and act more like a cooking oil than a water based compound in use. The mixture of gum and citrus fiber powder with the squash puree provides a cooking oil substitute which behaves much more like oil in use; allowing it to be widely used to replace cooking oil in many types of recipes and foods.

Turmeric powder in the example cooking oil substitute provides curcumin and has the potential to improve cholesterol and heart health and help prevent Alzheimer's disease and cancer. It is a potent anti-inflammatory and antioxidant and may also help improve symptoms of depression and arthritis. The turmeric gives an egg color to the cooking oil substitute and makes it easier to also replace eggs in a recipe without losing the color provides by the eggs. As discussed, there is better acceptance of healthier foods if the foods retain the color, texture, and flavor that people are accustomed to.

Citric acid is a preservative and helps prevent the formation of bacteria, mold, yeast, and fungus. It helps to preserve the color, flavor, and texture of the oil substitute and foods cooked with the oil substitute. Citric acid delays how quickly food spoils and increases the shelf life of foods cooked with the cooking oil substitute.

Prior attempts to replace cooking oil in recipes resulted in a substituted ingredient that did not well replicate the effects of the cooking oil. Prior oil substitutes may have preserved moisture in a baked food for a time, but did not preserve the consistency, appearance, or flavor of the food The substituted ingredient would replace oil with limited success in one recipe, but would not work in other recipes to replace cooking oil. Cooks desiring to replace cooking oil would have to recreate each recipe with different ingredient substitutions to replace the oil in each recipe and typically achieved limited success.

The cooking oil substitute may be used to make many different types of foods including breads, crackers, desserts, pasta, etc. It can be used for sautéing, baking, etc. The cooking oil substitute can also be used for other functions of cooking oil, such as brushing the cooking oil substitute top of bread or other foods before baking to impart a nice golden crust. The cooking oil substitute provides a more universal substitute for cooking oil.

The example cooking oil substitute does not require the formation of or interaction with gluten to function. Accordingly, the cooking oil substitute works in recipes that do not have flour or gluten and works in recipes that are gluten free and also sugar free. The cooking oil substitute provides health benefits for all people, but significantly benefits people with liver disease and fatty liver, diabetes, heart disease, and inflammation in their body. People who are genetically unable to metabolize fats and cooking oils may use the cooking oil substitute to eliminate fats and oils in their diet while still achieving foods that are desirable to eat. Preserving accustomed foods textures and flavors with the cooking oil substitute improves users' compliance in eliminating the fats and oils from their diet.

The above description of illustrated examples of the present invention, including what is described in the Abstract, is not intended to be exhaustive or to be limiting to the precise forms disclosed. While specific examples of the invention are described herein for illustrative purposes, various equivalent modifications are possible without departing from the broader scope of the present claims. Indeed, it is appreciated that specific example weights, percentages, etc., are provided for explanation purposes and that other values may also be employed in other examples in accordance with the teachings of the present invention.

What is claimed is:

1. A cooking oil substitute comprising a mixture of:
cooked and pureed butternut squash;
citrus fiber, wherein a weight of the citrus fiber is about 3 percent of a weight of the squash;
xanthan gum, wherein a weight of the xanthan gum is about 0.3 percent of the weight of the squash;
turmeric, wherein a weight of the turmeric is about 0.9 percent of the weight of the squash; and
citric acid powder; wherein a weight of the citric acid powder is about 0.7 percent of the weight of the squash.

2. The cooking oil substitute of claim 1, further comprising salt, wherein a weight of the salt is about 0.5 percent of the weight of the squash.

3. The cooking oil substitute of claim 1, further comprising added water, wherein a weight of the added water is about 250 percent of the weight of the squash.

4. A cooking oil substitute comprising a mixture of:
pureed squash;
citrus fiber, wherein a weight of the citrus fiber is between 1 percent and 7 percent of a weight of the squash; and
thickener, wherein a weight of the thickener is between 0.1 percent and 1 percent of the weight of the squash.

5. The cooking oil substitute of claim 4, wherein the weight of the citrus fiber is between 2 percent and 4 percent of the weight of the squash.

6. The cooking oil substitute of claim 4, wherein the weight of the citrus fiber is about 3 percent of the weight of the squash.

7. The cooking oil substitute of claim 4, wherein the thickener is xanthan gum, and wherein the weight of the xanthan gum is about 0.3 percent of the weight of the squash.

8. The cooking oil substitute of claim 4, further comprising turmeric, wherein a weight of the turmeric is about 0.9 percent of the weight of the squash.

9. The cooking oil substitute of claim 4, further comprising citric acid powder, wherein a weight of the citric acid powder is about 0.7 percent of the weight of the squash.

10. The cooking oil substitute of claim 4, further comprising salt, wherein a weight of the salt is about 0.5 percent of the weight of the squash.

11. The cooking oil substitute of claim 4, wherein a dry weight of the citrus fiber is about 8 times a dry weight of the xanthan gum.

12. The cooking oil substitute of claim 4, further comprising added water, wherein a weight of the added water is about 250 percent of the weight of the squash.

13. A cooking oil substitute comprising a mixture of:
dried squash powder; and
citrus fiber, wherein a weight of the citrus fiber is between 10 percent and 70 percent of a weight of the squash powder.

14. The cooking oil substitute of claim 13, wherein the weight of the citrus fiber is about 30 percent of the weight of the squash powder.

15. The cooking oil substitute of claim 13, further comprising a thickener, wherein a weight of the thickener is between 1 percent and 10 percent of the weight of the squash powder.

16. The cooking oil substitute of claim 13, wherein the thickener is xanthan gum, and wherein the weight of the xanthan gum is about 3 percent of the weight of the squash powder.

17. The cooking oil substitute of claim 13, further comprising turmeric, wherein a weight of the turmeric is about 9 percent of the weight of the squash powder.

18. The cooking oil substitute of claim 13, further comprising citric acid powder, wherein a weight of the citric acid powder is about 7 percent of the weight of the squash powder.

19. The cooking oil substitute of claim 13, further comprising salt, wherein a weight of the salt is about 5 percent of the weight of the squash powder.

20. The cooking oil substitute of claim 13, further comprising added water, wherein a weight of the added water is about 3400 percent of the weight of the squash powder.
